(19) United States
(12) Patent Application Publication
(10) Pub. No.: US 2006/0076716 A1
(43) Pub. Date: Apr. 13, 2006

(54) Device and method for moulding semi-finished pieces made from open-cell material

(76) Inventors: Johannes Hysky, Leichlingen (DE); Heinz Blomeling, Leichlingen (DE)

Correspondence Address: WILLIAM COLLARD;COLLARD & ROE, P.C., 1077 NORTHERN BOULEVARD, ROSLYN, NY, 11576, US

(21) Appl. No.: 10/540,291

(22) PCT Filed: Nov. 25, 2003
(86) PCT No.: PCT/EP03/13237

§ 371 Date: Jun. 20, 2005

(30) Foreign Application Priority Data
Dec. 18, 2002 (DE) 10259641.7

(51) Int. Cl. B28B 7/32

(52) U.S. Cl. 264/492; 264/324; 264/320; 264/314

(57) ABSTRACT

The present invention relates to a method for the shaping of web-like or sheet-like semifinished products (7, 8) made of open-pored plastic using a multipart forming tool (1), whose tool parts (2, 3), which may be moved toward and away from one another, define a cavity (4) having at least one mold structure. The present invention is essentially characterized in that at least one section of web-like or sheet-like semifinished product made of open-pored material is shaped in the cavity of the forming tool (1) by inflating a balloon or hose (18) made of elastic material which is assigned to the cavity (4). In this way, both open-pored thermoplastic materials and open-pored duroplastic materials can be shaped effectively and cost-effectively. In particular, the method according to the present invention allows the manufacture of open-pored shaped parts having undercuts (23, 24). The present invention further relates to a device for carrying out the method according to the present invention.

The present invention relates to a device and a method for the shaping of web-like or sheet-like semifinished products made of open-pored plastic using a multipart forming tool, whose tool parts, which may be moved toward and away from one another, define a cavity having at least one mold structure.

In automobile construction in particular, insulating components are used which are manufactured from foams and nonwoven materials and which are used for sound and/or thermal insulation. Insulating components of this type are typically implemented as shaped parts in order to adapt them to the space conditions at their installation location. In addition, the acoustic effectiveness of such insulating components may be influenced by their shape.

Various methods and devices for shaping semifinished products made of plastic are known in the related art.

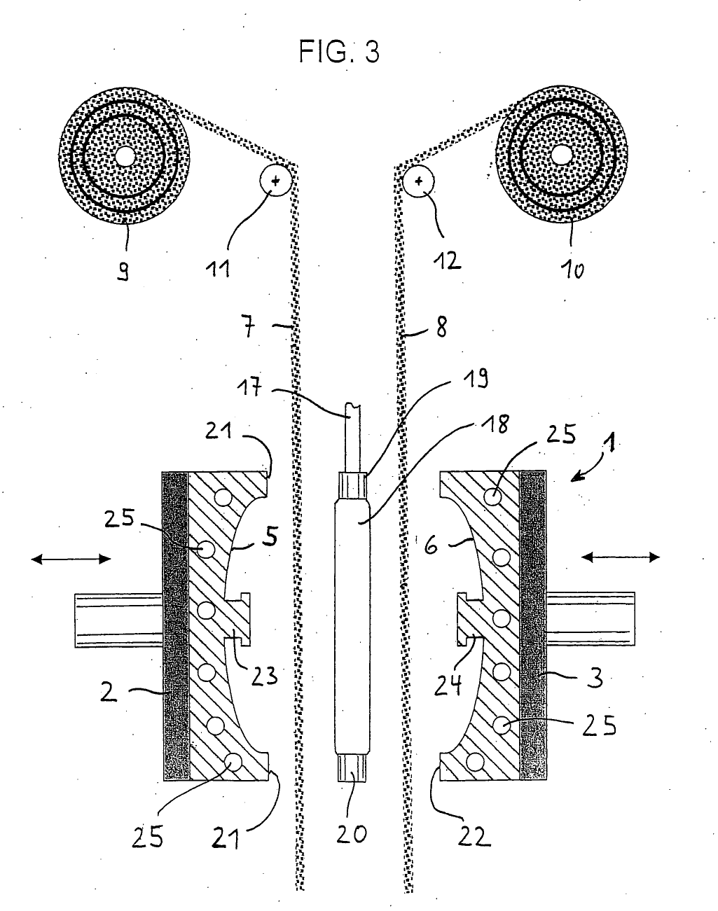

A known method for shaping semifinished products is deep drawing using positive and negative dies, for example. Providing the upper die with a cushion filled with water or attaching a rubber membrane to the upper die, which may have pressurized water applied to it via a pump, is also known in this context (cf. Saechtling, Kunststoff Taschenbuch [Plastics Handbook], 28th edition, 2001, Carl Hanser Verlag, p. 343, FIG. 3.128 and p. 348, FIG. 3.135).

Furthermore, extrusion blow molding in the processing of thermoplastic or thermoelastic plastics has been known for many years. In this case, an extruder is used to manufacture hose-shaped preforms. The preforms are squeezed between two movable halves of a blow mold tool and pressed against the inner wall of the tool using compressed air. The compressed air is supplied in this case through a blow pin, which may also be used simultaneously for calibrating a hollow body opening.

A method for manufacturing a hollow body from a permanently deformable foam through blow molding is described in DE 40 06 729 A1. According to this method, two sections of a closed-cell foam are first laid in a multipart mold after heating to a temperature above the softening temperature of the foam. By closing the multipart mold, the sections are welded to one another along their edges, the intermediate space between the sections being sealed. By introducing compressed air into the intermediate space between the sections, the sections are pressed against the walls of the multipart mold and shaped. After cooling of the sections, the shaped part is removed from the mold.

A method for manufacturing hollow body shaped parts from foams, in which an essentially air-impermeable foam or a foam containing at least one essentially air-impermeable layer is used, tubular preforms or preforms like hollow bodies first being produced from the foam, is known from DE 37 12 973 A1. The preforms are heated to a temperature lying in the thermoelastic or possibly up to the beginning thermoplastic state range and then introduced into divided forming tools having a cavity corresponding to the external contour of a hollow body to be manufactured. Heated air is then blown into the hollow interior of the preforms, so that the preforms are inflated to the desired hollow body shaped part. The hollow body shaped parts are then solidified through cooling and finally removed from the mold after sufficient solidification.

The object of the present invention is to specify a method and a device, using which open-pored thermoplastic materials and open-pored duroplastic materials can be shaped effectively and cost-effectively. In particular, also undercuts in the shaped parts are to be produced in a simple way.

In regard to the method, this object is achieved according to the present invention by a method of the type mentioned at the beginning in that at least one section of a web-like or sheet-like semifinished product made of open-pored material is shaped in the cavity of the forming tool by inflating a balloon or hose made of elastic material which is assigned to the cavity.

Using the method according to the present invention, both semifinished products made of open-pored thermoplastic materials, such as open-celled thermoplastic foams or thermoplastic nonwoven materials, and also semifinished products made of open-pored duroplastic materials, such as melamine resin foams, may be shaped cost-effectively into shaped parts having complex contours. In particular, the method according to the present invention allows open-pored shaped parts having undercuts to be manufactured.

In the method according to the present invention, in contrast to the related art, no preform is manufactured and therefore at least one work step is saved. In particular, in the method according to the present invention, neither coating of the open-pored material with an air-impermeable layer nor foaming of the material occur. In addition, in the shaping of web-like or sheet-like semifinished products made of open-pored foam according to the present invention, no cross-linking of the foam is necessary.

Furthermore, the object specified above is achieved in regard to the device by a device having the features specified in Claim 9. The device according to the present invention therefore comprises a multipart forming tool whose tool parts, which may be moved toward and away from one another, form a cavity having at least one mold structure, and at least one blowing pin assigned to the cavity, which is provided with a balloon or hose made of elastic material which may be inflated inside the cavity of the forming tool to shape at least one section of a web-like or sheet-like semifinished product made of open-pored material.

The device according to the present invention is therefore set up for shaping web-like or sheet-like semifinished products made of open-pored plastic material.

An advantageous embodiment of the present invention is that several web-like or sheet-like semifinished products made of open-pored material may be shaped simultaneously in the cavity by inflating the balloon or hose. In this way, the output of a device according to the present invention may be increased correspondingly.

In regard to the shaping of web-like or sheet-like semifinished products made of open-pored thermoplastic material, it is advantageous if a heating device for heating the semifinished product is arranged upstream from the forming tool. In this way, the thermoplastic semifinished product may be heated to an optimum shaping temperature even before being positioned in the forming tool, the heating preferably being performed parallel in time to the shaping of a prior semifinished product or semifinished product section, so that the total processing time necessary for the shaping is minimized.

The heating device may preferably comprise movable heating plates. Alternatively or additionally, radiant heaters may also be used as the heating device.

Further preferred and advantageous embodiments of the present invention are specified in the subclaims.

In the following, the present invention will be explained in greater detail on the basis of a drawing which illustrates several exemplary embodiments.

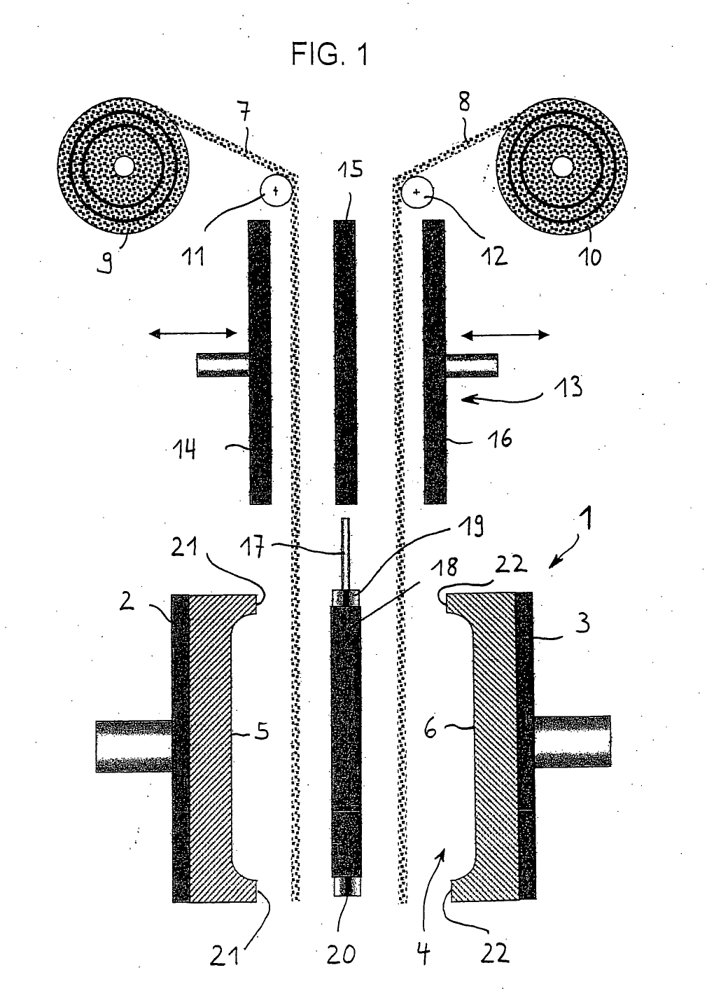

FIG. 1 schematically shows a first exemplary embodiment of a device according to the present invention for shaping two web-like semifinished products made of open-pored thermoplastic material while the material is fed into the open forming tool,

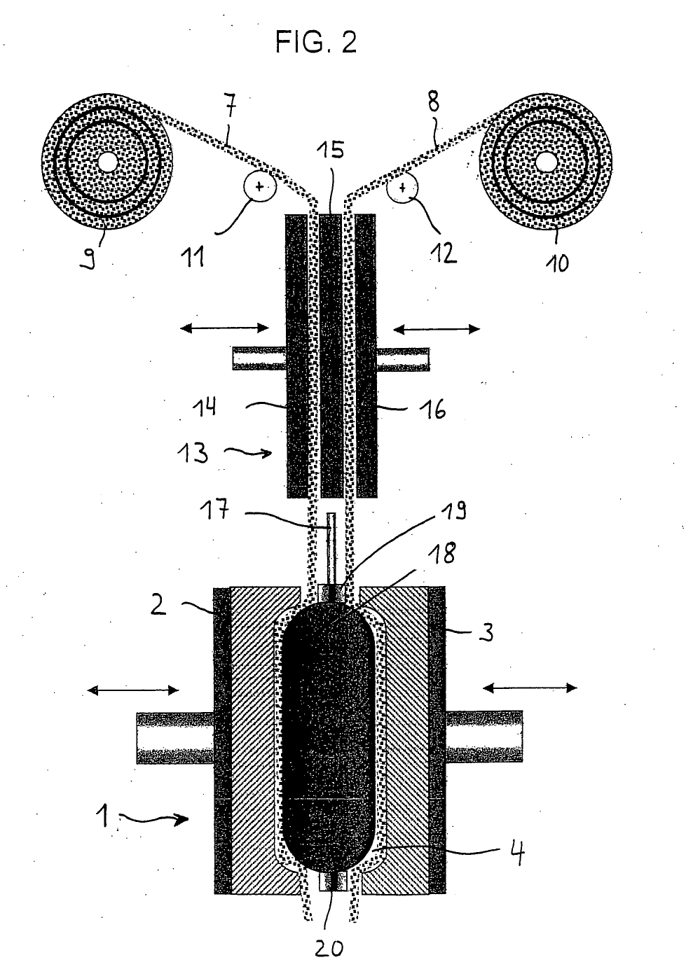

FIG. 2 schematically shows the device shown in FIG. 1 with the forming tool closed during the shaping of two sections of the web-like semifinished products made of open-pored material,

FIG. 3 schematically shows a second exemplary embodiment of a device according to the present invention for shaping two web-like semifinished products made of open-pored duroplastic material as the material is fed into the open forming tool, and

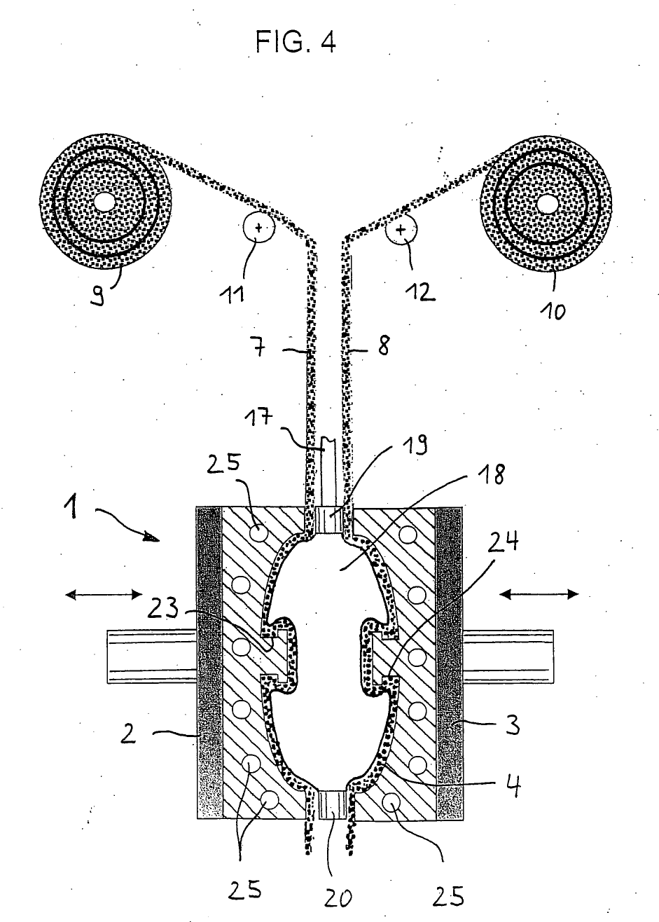

FIG. 4 schematically shows the device shown in FIG. 3 with the forming tool closed during the shaping of two sections of the web-like semifinished products made of open-pored, duroplastic material.

The device shown in FIGS. 1 and 2 has a forming tool 1 made of two halves. The two tool halves (tool parts) 2, 3 are movable in relation to one another and define a cavity 4. Each of the two tool halves has a mold structure on its interior, a negative mold in this case.

As shown in FIG. 1, the forming tool 1 may be opened by moving the two tool halves (tool parts) 2, 3 apart from one another. Material webs 7, 8 are fed between the two tool halves 2, 3, which have been moved apart, from above. The essentially flat material webs 7, 8 are each unrolled in this case from a coil 9, 10 and guided to the forming tool 1 via a deflection roller 11, 12. The feed of the material webs 7, 8 and the opening and closing of the forming tool 1 are chronologically coordinated to one another and occur under clock control.

In this exemplary embodiment, the material webs 7, 8 each comprise an open-pored, thermoplastic material. The material may be open-celled thermoplastic foam, thermoplastic nonwoven, or a multilayer web of such open-pored materials, for example.

A heating device 13 is connected upstream from the forming tool 1. The heating device 13 forms a preheating station. In this exemplary embodiment, it has three heating plates 14, 15, 16 for contact heating of sections of the material webs 7, 8. While the central heating plate 15 is positioned fixed, the two external heating plates 14, 16 may be moved in the direction of the double arrows using a drive device (not shown). Alternatively or additionally to the heating plates 14, 15, 16, radiant heaters (not shown) may also be used for heating sections of the material webs 7, 8.

A blowing pin 17, which is connected via a compressed air line (not shown) to a compressed air source and/or a compressed air generator, is assigned to the cavity 4 of the forming tool 1. The blowing pin 17 is provided with an inflatable hose 18 made of elastic material.

The hose 18 is connected airtight at one end to the blowing pin 17 using a collar 19 and is closed airtight at its other end using a removable seal 20. The collar 19 and the seal 20 are positioned at a fixed distance to one another. This may be implemented by a pipe (not shown) positioned in the hose 18 or a corresponding rod (not shown), for example, the pipe or the rod, respectively, being permanently connected or connectable to the collar 19 and the seal 20. The pipe may represent an extension of the blowing pin 17 and have multiple passage openings in this case. The distance from the collar 19 to the seal 20 is dimensioned so that when the forming tool 1 is closed, the collar 19 and the seal 20 are clamped, together with small sections of the material webs 7, 8, in recesses (not shown), which are implemented in the edge sections 21, 22 of the tool halves 2, 3 facing toward one another.

When the forming tool 1 is closed, the two sections of the material webs 7, 8 are pressed together at the edge sections 21, 22 of the tool halves 2, 3. The contact pressure is dimensioned in this case in such a way that upon inflation of the elastic hose 18, some web material may slide further into the cavity 4. The tool halves 2, 3 may also be provided with a stretcher (not shown) for this purpose.

The sections of the material webs 7, 8 located inside the cavity 4 of the forming tool 1 are pressed against the inside of the tool halves 2, 3 by the inflation of the elastic hose 18 and shaped in accordance with the mold structure 5, 6 of the tool halves 2, 3. The mold structure may particularly also have undercuts 23, 24 (cf. FIG. 4). After cooling of the shaped material sections, the compressed air is let out of the hose 18 and the hose is thus relaxed. For this purpose, a multidirectional valve (not shown) positioned in the compressed air line, to which a relief branch is connected, is actuated. The shaped parts produced are then removed from the forming tool. The forming tool 1 is relatively cold. To shorten the cooling time, the tool halves 2, 3 may also be equipped with a cooling device (not shown), which is used to cause forced cooling.

It may be seen in FIG. 2 that while the material sections are shaped in the forming tool 1, the subsequent material sections, which have not yet been shaped, are being heated in the heating device 13.

A cutting device (not shown) may additionally be assigned to the forming tool 1, in order to cut off the shaped parts produced in the material webs 7, 8 therefrom. It is also possible to feed material sections which are already cut to length to the forming tool 1.

The elastic hose 18 may have a shape adapted to the shape of the tool cavity 4, so that it has a cushion-like shape or a complex balloon shape, for example. Assigning several inflatable elastic hoses or the like to the tool cavity 4 is also within the scope of the present invention.

The device shown in FIGS. 3 and 4 is intended for shaping open-pored duroplastic material. This material may, for example, be an open-pored melamine resin foam, which is impregnated with a thermosetting binder such as melamine resin or phenol resin.

In this exemplary embodiment as well, the open-pored duroplastic material is provided as wound-up material web 7, 8, which is fed to the forming tool 1 via deflection rollers 11, 12. The forming tool 1 again comprises two tool parts or tool halves 2, 3. The two tool halves 2, 3 are movable in relation to one another in the direction of the double arrows. They each have a heating device.

The heating device is realized here by one or more heating channels 25 implemented in the tool halves 2, 3, through which hot water or another heating fluid circulates. Instead of heating channels 25, electrical heating wires (not shown) may also be integrated into the tool halves 2, 3.

A blowing pin 17 is assigned to the tool halves 2, 3, as in the exemplary embodiment described above, which is positioned between the tool halves 2, 3 and is provided with an elastic hose 18 or the like. The design of the hose 18 and its attachment to the blowing pin 17 correspond to the exemplary embodiment shown in FIGS. 1 and 2. Before the elastic hose 18 is inflated, the forming tool 1 is closed so that the collar 19 and the removable seal 20 are clamped, together with small sections of the material webs 7, 8, in recesses (not shown), which are implemented in the edge sections 21, 22 of the tool halves 2, 3.

As indicated in FIGS. 3 and 4, the mold structure 5, 6 of the tool halves 2, 3 may have one or more undercuts 23, 24. The use of the inflatable elastic hose 18 allows the open-pored material to be pressed into the region of the undercuts 23, 24 and shaped accordingly. In addition, the use of an inflatable elastic hose 18 or balloon allows the simultaneous shaping of several open-pored semifinished products. The shaped parts thus produced may be removed without problems from the forming tool 1 after their thermosetting binder has hardened, since they are still sufficiently elastic even after the hardening.

### LIST OF REFERENCE NUMBERS

1 forming tool (mold)
2 tool half
3 tool half
4 cavity
5 mold structure
6 mold structure
7 material web (semifinished product)
8 material web (semifinished product)
9 coil
10 coil
11 deflection roller
12 deflection roller
13 heating device
14 heating plate
15 heating plate
16 heating plate
17 blowing pin
18 elastic hose
19 sealed collar
20 removable seal
21 edge section of one tool half
22 edge section of the other tool half
23 undercut
24 undercut
25 heating channel

1-16. (canceled)

17. A method for shaping of web-like or sheet-like semifinished products (7, 8) made of plastic using a multipart forming tool (1), whose tool parts (2, 3), which are movable toward and away from one another, define a cavity (4) having at least one mold structure (5, 6), in which several semifinished products (7, 8) are heated simultaneously in the cavity (4) of the forming tool (1) and shaped by inflating a balloon or hose (18) made of elastic material which is assigned to the cavity (4), wherein the semifinished products (7, 8) to be shaped are semifinished products made of open-pored duroplastic which are impregnated with a thermosetting binder, the semifinished products (7, 8) are heated using heating devices (25) integrated into the tool parts (2, 3), and several shaped parts are produced from the open-pored semifinished products (7, 8) during each shaping.

18. A method for shaping web-like or sheet-like semifinished products (7, 8) made of plastic using a multipart forming tool (1), whose tool parts (2, 3), which are movable toward and away from one another, define a cavity (4) having at least one mold structure (5, 6), in which the semifinished products (7, 8) are heated before being fed into the forming tool (1) and several semifinished products (7, 8) are shaped in the cavity (4) of the forming tool (1) by inflating a balloon or hose (18) made of elastic material which is assigned to the cavity (4), wherein the semifinished products (7, 8) to be shaped are semifinished products made of open-pored thermoplastic, the heating of the semifinished products (7, 8) occurs parallel in time to the shaping of prior semifinished products, and several shaped parts are produced from the open-pored semifinished products (7, 8) during each shaping.

19. The method according to claim 18,
wherein the semifinished products (7, 8) are heated through contact heating or through radiant heating.

20. The method according to claim 17,
wherein the shaped parts produced from the semifinished products (7, 8) are cooled in the forming tool (1).

21. The method according to claim 17,
wherein a forming tool (1) whose at least one mold structure (5, 6) has at least one undercut (23, 24) is used.

22. The method according to claim 17,
wherein the open-pored semifinished products (7, 8) are fed to the forming tool (1) as web product unwound from coils (9, 10).
